(19) United States
(12) Patent Application Publication
(10) Pub. No.: US 2008/0121023 A1
(43) Pub. Date: May 29, 2008

(54) Masticatory Efficiency Measuring Apparatus and Masticatory Efficiency Measuring Method Using the Same

(75) Inventors: Takashi Nokubi, Osaka (JP); Kazunori Ikebe, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: OSAKA UNIVERSITY, Suita-shi, Osaka (JP)

(21) Appl. No.: 11/666,105

(22) PCT Filed: Sep. 20, 2005
(86) PCT No.: PCT/JP05/17671

§ 371 Date: Apr. 23, 2007

(30) Foreign Application Priority Data
Oct. 26, 2004 (JP) 2004-310754

(51) Int. Cl. G01N 37/00

(52) U.S. Cl. 73/61.43

(57) ABSTRACT

A masticatory efficiency measuring apparatus of the present invention includes a tank (3) that contains a stirring liquid to be supplied to a measuring container (2), a heater for heating the stirring liquid in the tank (3), a stirring device for stirring chewed food pieces in the stirring liquid with the measuring container (2) containing the chewed food pieces and the stirring liquid, a concentration meter (5) for measuring the concentration of a food component eluted into the stirring liquid from surfaces of the chewed food pieces, and a control device. The control device controls operations of the heater, stirring device and concentration meter (5), and determines the masticatory efficiency evaluating value based on the measurement result of the concentration meter (5).

### TECHNICAL FIELD

The present invention relates to an apparatus capable of mechanically measuring the masticatory efficiency without depending on manual operation of a user, and to a masticatory efficiency measuring method using the same.

### BACKGROUND ART

A sieve method using peanuts has been conventionally used worldwide as a masticatory efficiency measuring method.

In the sieve method using peanuts, a subject masticates an about 3 g peanut by a predetermined number of strokes, and thereafter all crushed pieces of the peanut are collected and sifted with a sieve having a roughness of 10 mesh. Subsequently, crushed peanut pieces that remain on the sieve are dried at 80° C. for one hour and thereafter weighed, so that the weight of crushed peanut pieces that have sifted is calculated from the weighed result. Then, from the calculation result, the weight % of the crushed peanut pieces that have sifted relative to the peanut before masticated is calculated to be the masticatory efficiency evaluating value.

However, the masticatory efficiency measuring method using peanuts has been suffering from a problem of low masticatory efficiency measurement accuracy because peanuts are a natural food and various in size and hardness. Another problem is that the masticatory efficiency measurement takes a long time because the masticated and crushed peanut pieces need to be dried.

Accordingly, a masticatory efficiency measuring method using gummy jelly has been developed in order to solve the above problems. The measurement is performed by manual operation of a measurer. The term “gummy jelly” refers herein to a gelatin and glucose containing food that is elastic and can be broken into pieces when masticated.

In the masticatory efficiency measuring method using gummy jelly, a subject masticates a testing gummy jelly by a predetermined number of strokes, and thereafter all chewed pieces of the gummy jelly are collected and washed with tap water. Thereafter, the chewed and washed gummy jelly pieces are stirred in distilled water to allow gelatin contained in the gummy jelly to be eluted into the distilled water from surfaces of the chewed gummy jelly pieces. Then, the gelatin concentration is measured with a spectrophotometer, so that the surface area increment of the chewed gummy jelly pieces is calculated from the measurement result to be the masticatory efficiency evaluating value.

The masticatory efficiency measuring method using gummy jelly can achieve high measurement accuracy, compared with the conventional measuring method using peanuts, because gummy jellies can be produced in a uniform shape and dimension. In addition, it takes a short time to provide the measurement result, compared with the conventional measuring method using peanuts, because the masticated gummy jelly pieces do not need to be dried.

However, the applicants' study has proved that, although providing improved measurement accuracy compared with the masticatory efficiency measuring method using peanuts, the masticatory efficiency measuring method using gummy jelly cannot achieve sufficiently high measurement accuracy.

An object of the present invention is to provide a masticatory efficiency measuring apparatus capable of achieving sufficiently high measurement accuracy, and a masticatory efficiency measuring method using the same.

### DISCLOSURE OF THE INVENTION

The present inventors conducted an intensive study in order to investigate possible causes of failure of the conventional masticatory efficiency measuring method using gummy jelly to achieve sufficiently high measurement accuracy. Consequently, they completed the present invention, finding that the measured value of masticatory efficiency is greatly influenced by the time for which chewed gummy jelly pieces are stirred in distilled water (elution time) and by the distilled water temperature (elution temperature).

A masticatory efficiency measuring apparatus of the present invention includes a stirring liquid supply mechanism for supplying a stirring liquid to a measuring container; a heating mechanism for heating the stirring liquid; a stirring mechanism for stirring chewed pieces of a masticatory efficiency measuring food in the stirring liquid, with the measuring container containing the chewed pieces and the stirring liquid; a concentration measuring device for measuring the concentration of a component of the masticatory efficiency measuring food eluted into the stirring liquid from surfaces of the chewed pieces of the food; and a control device for controlling operations of the stirring liquid supply mechanism, heating mechanism, stirring mechanism and concentration measuring device, and for determining the masticatory efficiency evaluating value based on the measurement result of the concentration measuring device.

In a first specific configuration, the control device is for causing the heating mechanism to heat the stirring liquid to a predetermined temperature, and the stirring mechanism to stir the chewed pieces for a predetermined time, and includes:

relationship defining means that defines a relationship between the concentration of the component of the masticatory efficiency measuring food and the masticatory efficiency evaluating value, and in the case where the stirring liquid supplied from the stirring liquid supply mechanism to the measuring container has the predetermined temperature, and is stirred for the predetermined time; and

masticatory efficiency evaluating value determining means for determining the masticatory efficiency evaluating value from the measurement result of the concentration measuring device, in accordance with the relationship defined by the relationship defining means.

The term “masticatory efficiency measuring food” refers to a food that can be broken into pieces when masticated, and includes various kinds of food such as gummy jelly and raw rice.

In measurement using the masticatory efficiency measuring apparatus having the first specific configuration, first, a subject masticates a masticatory efficiency measuring food, and thereafter chewed pieces of the food are collected and washed by manual operation of a measurer, or mechanically by a washing device. This removes the saliva that has been attached to the chewed pieces while the food has been masticated.

Subsequently, the chewed food pieces washed as described above are put into the measuring container, and the stirring liquid supply mechanism supplies a stirring liquid to the measuring container. Thereafter, the stirring mechanism stirs the chewed food pieces in the stirring liquid for a predetermined time. This causes a component of the food, for example, glucose or gelatin, if the food is gummy jelly, to be eluted into the stirring liquid from surfaces of the chewed pieces. Thereafter, the concentration measuring device measures the concentration of the component. Finally, the control device determines the masticatory efficiency evaluating value from the measurement result of the concentration measuring device, in accordance with the relationship defined by the relationship defining means.

The above masticatory efficiency measuring apparatus can provide high measurement accuracy, because the control device controls the heating mechanism to thereby allow the temperature of the stirring liquid to be accurately set to a predetermined temperature, and because the control device controls the stirring mechanism to thereby allow the chewed food pieces to be stirred in the stirring liquid accurately for a predetermined time.

A second specific configuration includes thermometry means for measuring the temperature of the stirring liquid supplied from the stirring liquid supply mechanism to the measuring container; and timing means for measuring the time for which the chewed pieces of the masticatory efficiency measuring food are stirred in the stirring liquid, and the control device includes:

relationship defining means that defines a plurality of relationships between the concentration of the component of the masticatory efficiency measuring food and the masticatory efficiency evaluating value; and

masticatory efficiency evaluating value determining means for selecting a relationship according to the measurement result of the thermometry means and the timing result of the timing means from the plurality of relationships defined by the relationship defining means, and for determining the masticatory efficiency evaluating value from the measurement result of the concentration measuring device, in accordance with the selected relationship.

As in the measurement using the masticatory efficiency measuring apparatus having the first specific configuration, in measurement using the masticatory efficiency measuring apparatus having the second specific configuration, first, a subject masticates a masticatory efficiency measuring food, and thereafter chewed pieces of the food are collected and washed by manual operation of a measurer, or mechanically by a washing device.

Subsequently, the chewed and washed food pieces are put into the measuring container, and the stirring liquid supply mechanism supplies a stirring liquid to the measuring container. Thereafter, the stirring mechanism stirs the chewed food pieces in the stirring liquid. This causes a component of the food, for example, glucose or gelatin, if the food is gummy jelly, to be eluted into the stirring liquid from surfaces of the chewed pieces. Thereafter, the concentration measuring device measures the concentration of the component. Finally, the control device selects a relationship according to the actual temperature of the stirring liquid supplied from the stirring liquid supply mechanism to the measuring container and the actual time for which the chewed food pieces have been stirred, from a plurality of relationships defined by the relationship defining means, and determines the masticatory efficiency evaluating value from the measurement result of the concentration measuring device, in accordance with the selected relationship.

The above masticatory efficiency measuring apparatus determines the masticatory efficiency evaluating value in accordance with the relationship between the actual temperature of the stirring liquid supplied to the measuring container and the actual time for which the chewed food pieces have been stirred. This can provide high measurement accuracy.

Specifically, the apparatus includes a supernatant liquid collecting/supply mechanism for collecting the supernatant liquid in the measuring container for supply to the concentration measuring device, the supernatant liquid collecting/supply mechanism being operation-controlled by the control device. This specific configuration enables the supernatant liquid collecting/supply mechanism to mechanically collect the supernatant liquid in the measuring container for supply to the concentration measuring device, after the chewed food pieces are stirred in the stirring liquid.

More specifically, the apparatus includes a washing mechanism for washing the chewed pieces of the masticatory efficiency measuring food with washing water, the washing mechanism being operation-controlled by the control device. This specific configuration enables the washing mechanism to mechanically wash the chewed food pieces after the masticatory efficiency measuring food is masticated.

Further specifically, the control device causes the washing mechanism to wash the chewed pieces of the masticatory efficiency measuring food for a predetermined time.

A short washing time for the chewed food pieces would not completely remove the saliva that has been attached to surfaces of the chewed pieces while the food has been masticated, and would result in the stirring liquid in the measuring container containing components of food contained in the saliva, preventing accurate measurement of the concentration of the component eluted from surfaces of the chewed food pieces. On the other hand, a washing time for the chewed food pieces longer than a certain time will completely remove the saliva that has been attached to the chewed pieces while the food has been masticated, and will result in the stirring liquid in the measuring container containing only components eluted from surfaces of the chewed food pieces, enabling accurate measurement of the concentration of the component. Accordingly, the predetermined time is set to a time through which the saliva that has been attached to surfaces of the chewed pieces while the food has been masticated can be completely removed.

Furthermore specifically, the masticatory efficiency measuring food is gummy jelly, and the concentration measuring device measures the concentration of glucose, which is a component of the gummy jelly. A glucose meter, for example, is employed as the concentration measuring device. This specific configuration can provide the measurement result in a short time, compared with a configuration for measuring the gelatin concentration with a spectrophotometer.

As described above, the masticatory efficiency measuring apparatus of the present invention and the masticatory efficiency measuring method using the same can provide sufficiently high measurement accuracy.

### BRIEF DESCRIPTION OF THE DRAWINGS

FIG. 1 is a perspective view showing an appearance of a masticatory efficiency measuring apparatus of the present invention;

FIG. 2 is a block diagram showing the electric configuration of the masticatory efficiency measuring apparatus;

FIG. 3 is a process drawing showing a masticatory efficiency measuring method;

FIG. 4 is a graph showing the relationship between the washing temperature and the concentration of glucose;

FIG. 5 is a graph showing the relationship between the washing time and the concentration of glucose;

FIG. 6 is a graph showing the relationship between the elution temperature and the concentration of glucose;

FIG. 7 is a graph showing the relationship between the elution time and the concentration of glucose; and

FIG. 8 is a graph showing the surface area increment of gummy jelly and the concentration of glucose.

### BEST MODE FOR CARRYING OUT THE INVENTION

An embodiment of the present invention will be specifically described below with reference to the drawings. Described below is use of gummy jelly as a masticatory efficiency measuring food to calculate the surface area increment of chewed gummy jelly pieces to be the masticatory efficiency evaluating value from the concentration of glucose, which is a component of the gummy jelly.

Before description of a masticatory efficiency measuring apparatus of the present invention, there are described experiments, and results thereof, which the present inventors conducted when they developed the apparatus in order to investigate possible causes of conventional failure to provide sufficiently high measurement accuracy.

### EXPERIMENTS

Each experiment described below was conducted using a gummy jelly consisting of components shown in Table 1 below.

TABLE 1

| Material | Amount (g) |
|---|---|
| Malt Sugar | 690.0 |
| Sorbitol | 148.0 |
| Glucose | 119.0 |
| Granulated Sugar | 571.0 |
| Maltrup | 690.0 |
| Gelatin | 105.0 |
| Flavor and Others | 108.0 |

In each experiment, first, a subject freely masticated one gummy jelly without swallowing it in the middle, and thereafter chewed pieces of the gummy jelly were collected such that no piece was left in the mouth. The chewed and collected gummy jelly pieces were then washed with tap water. Next, the chewed gummy jelly pieces and distilled water were put into a beaker, and then the chewed gummy jelly pieces were stirred in the distilled water to allow the component of the gummy jelly to be eluted into the distilled water from surfaces of the chewed gummy jelly pieces. Subsequently, the supernatant liquid in the beaker was collected with a pipette, and dropped onto a sterilized stainless butt. Thereafter, the concentration of glucose eluted from surfaces of the chewed gummy jelly pieces was measured with a glucose meter.

### (1) Experiment 1

An experiment was conducted to examine the relationship between the washing temperature for the chewed gummy jelly pieces and the glucose concentration.

In the experiment, the chewed glucose pieces were washed using tap water of 23° C., which is near the temperature of the examination room, and tap water of 40° C., which probably elutes glucose more easily. For each washing temperature, five gummy jellies of original form (surface area 1600 mm²), five gummy jellies divided into eight equal parts (surface area 3200 mm²), and five gummy jellies divided into 16 equal parts (surface area 4000 mm²) were used. The glucose concentration was measured only once for one gummy jelly. The number of strokes of mastication was set to zero, five and ten, with the washing time for the chewed glucose pieces being 30 seconds, the temperature of distilled water supplied to the beaker 35° C., the volume of the distilled water 15 ml, and the stirring time for the chewed gummy jelly pieces 20 seconds.

### (2) Experiment 2

An experiment was conducted to examine the relationship between the washing time for the chewed gummy jelly pieces and the glucose concentration.

In the experiment, the glucose concentration was measured in the case where the masticated gummy jelly pieces were not washed with water and were stirred in distilled water (washing time 0 seconds), and in the case where the masticated gummy jelly pieces were washed with water for 10, 20, 30, 40, 50 and 60 seconds, and thereafter stirred in distilled water. For each washing time, five gummy jellies divided into 16 equal parts were used. The glucose concentration was measured only once for one gummy jelly. The number of strokes of mastication was set to ten, with the washing temperature for the chewed gummy jelly pieces being 23° C., the temperature of distilled water supplied to the beaker 35° C., the volume of the distilled water 15 ml, and the stirring time for the chewed gummy jelly pieces 20 seconds.

### (3) Experiment 3

An experiment was conducted to examine the relationship between the glucose elution temperature (temperature of the distilled water) and the glucose concentration.

In the experiment, the masticated and washed gummy jelly pieces were stirred in distilled water of 20° C., 30° C., 35° C., 40° C. and 50° C. For each temperature, five gummy jellies divided into 16 equal parts were used. The glucose concentration was measured only once for one gummy jelly. The number of strokes of mastication was set to ten, with the washing temperature for the chewed gummy jelly pieces being 23° C., the washing time 30 seconds, the volume of distilled water supplied to the beaker 15 ml, and the stirring time for the chewed gummy jelly pieces 20 seconds.

### (4) Experiment 4

An experiment was conducted to examine the relationship between the glucose elution time (stirring time) and the glucose concentration.

In the experiment, the masticated and washed gummy jelly pieces were stirred in distilled water for 10, 20, 30, 40, 50 and 60 seconds. For each stirring time, five gummy jellies divided into 16 equal parts were used. The glucose concentration was measured only once for one gummy jelly. The number of strokes of mastication was set to ten, with the washing temperature for the chewed gummy jelly pieces being 23° C., the washing time 30 seconds, the temperature of distilled water supplied to the beaker 35° C., and the volume of the distilled water 15 ml.

### EXPERIMENTAL RESULTS

Next, results of Experiments 1-4 are described. A statistical analysis method of Kruskal-Wallistest or Mann-Whitney's U-test was used for tests for significant differences with a significance level of 5%. If there was a significant difference, a multiple comparison test was conducted with Bonferroni method.

### (1) Experiment 1

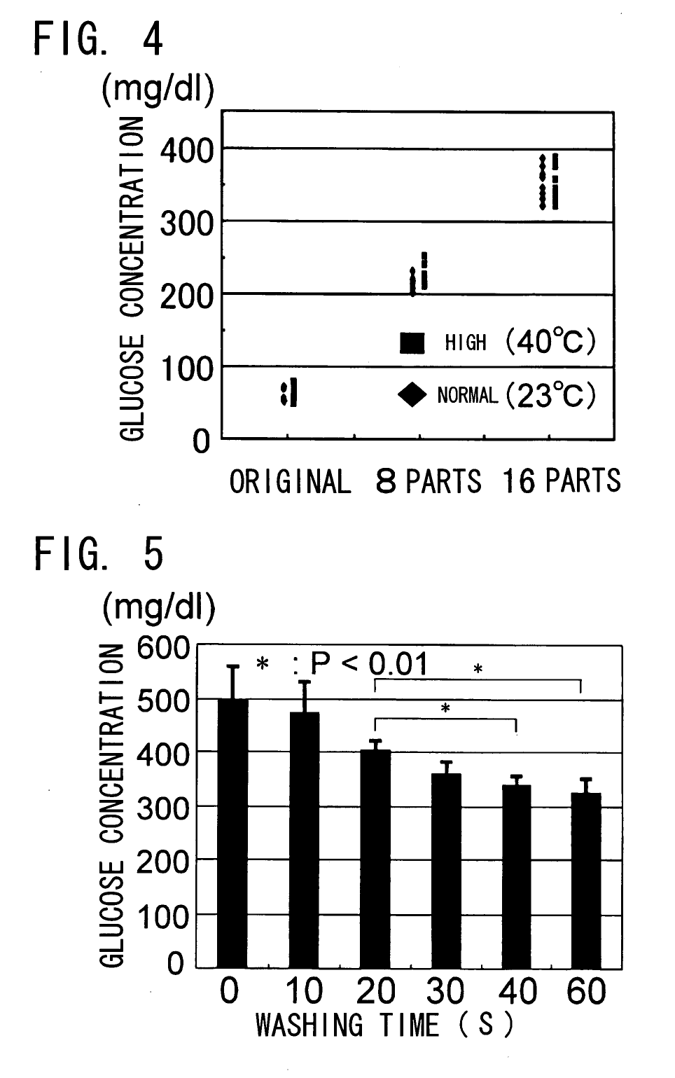

FIG. 4 shows the result of the above Experiment 1. As illustrated, the washing temperature provides no significant difference in glucose concentration. This indicates that the washing temperature has little influence on the measurement of masticatory efficiency.

### (2) Experiment 2

FIG. 5 shows the result of the above Experiment 2. As illustrated, the longer the washing time is, the lower the glucose concentration is, with a washing time of 30 seconds or more giving an approximately constant glucose concentration. Examination for significant differences has found that there is a significant difference in glucose concentration between the washing time of 20 seconds and that of 40 seconds, and between 20 seconds and 60 seconds, but there is no significant difference in glucose concentration between the washing time of 30 seconds and that of 40 seconds, and between 30 seconds and 60 seconds. The reason why a washing time of 30 seconds or more thus gives an approximately constant glucose concentration is probably that the saliva that has been attached to surfaces of the chewed pieces while the gummy jelly has been masticated is completely removed when about 30 seconds elapse from the start of washing of the chewed glucose pieces. It may be desirable to set the washing time to 30 seconds because a shorter measurement time for masticatory efficiency is clinically desired.

### (3) Experiment 3

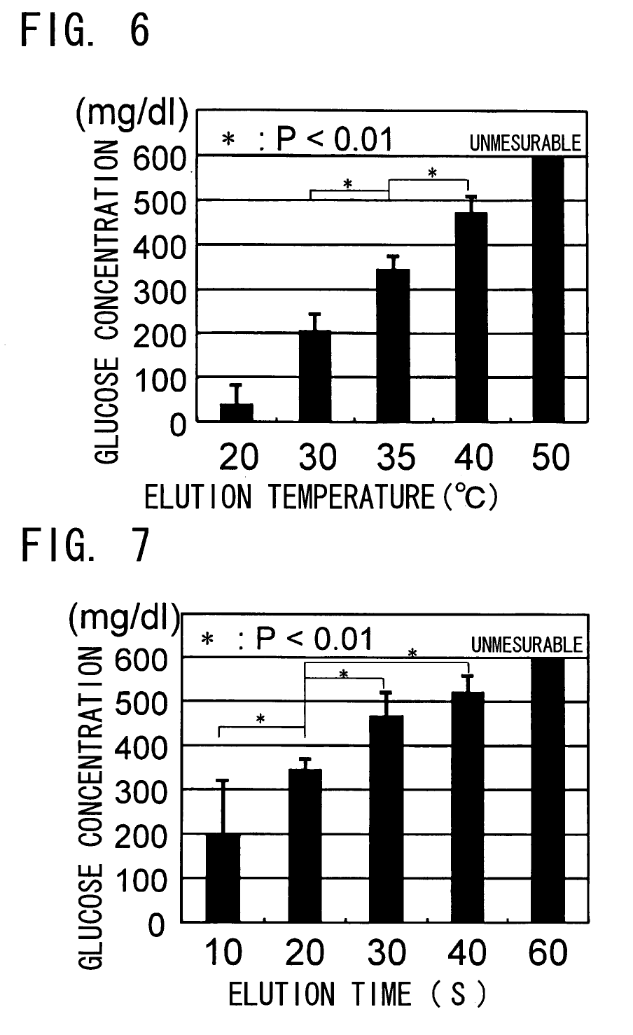

FIG. 6 shows the result of the above Experiment 3. As illustrated, the higher the elution temperature is, the higher the glucose concentration is. Examination for significant differences has found that there is a significant difference in glucose concentration between the elution temperature of 30° C. and that of 35° C., and between 35° C. and 40° C. The glucose concentration thus varies greatly depending on the elution temperature. Therefore, it may be necessary to strictly keep the elution temperature in order to obtain high accuracy for the measurement of masticatory efficiency. In the case of the elution temperature of 50° C., the glucose concentration was beyond the measurable range of the glucose meter, and unable to be measured.

### (4) Experiment 4

FIG. 7 shows the result of the above Experiment 4. As illustrated, the longer the elution time is, the higher the glucose concentration is. Examination for significant differences, which was conducted with the glucose concentration at the elution time of 20 seconds being a reference, has found that there is a significant difference in glucose concentration relative to each elution time of 10 seconds, 30 seconds, and 40 seconds. The glucose concentration thus varies greatly depending on the elution time. Therefore, it may be necessary to strictly keep the elution time in order to obtain high accuracy for the measurement of masticatory efficiency. In the case of the elution time of 60 seconds, the glucose concentration was beyond the measurable range of the glucose meter, and unable to be measured.

The present inventors conducted an additional experiment as described below in order to examine the relationship between the increment of surface area of the gummy jelly and the glucose concentration.

First, a subject freely masticated one gummy jelly, and thereafter all the chewed gummy jelly pieces were collected. The chewed and collected gummy jelly pieces were then washed using tap water of 23° C. for 30 seconds. Next, the chewed gummy jelly pieces and distilled water were put into a beaker, and then the chewed gummy jelly pieces were stirred in the 15 ml of distilled water of 35° C. for 20 seconds to allow glucose to be eluted into the distilled water from surfaces of the chewed gummy jelly pieces. Subsequently, the supernatant liquid in the beaker was collected with a pipette, and dropped onto a stainless butt. Thereafter, the concentration of glucose eluted from surfaces of the chewed gummy jelly pieces was measured with a glucose meter. In the experiment, five gummy jellies of original form (surface area 1600 mm²), five gummy jellies divided into eight equal parts (surface area 3200 mm²), five gummy jellies divided into 16 equal parts (surface area 4000 mm²) and five gummy jellies divided into 32 equal parts (surface area 4400 mm²) were used. The glucose concentration was measured only once for one gummy jelly.

Thereafter, statistical analysis was conducted using Spearman's correlation coefficient by rank test. Simple linear regression analysis was also conducted with the explanatory variable being the glucose concentration, and the response variable the increment of surface area of the gummy jelly.

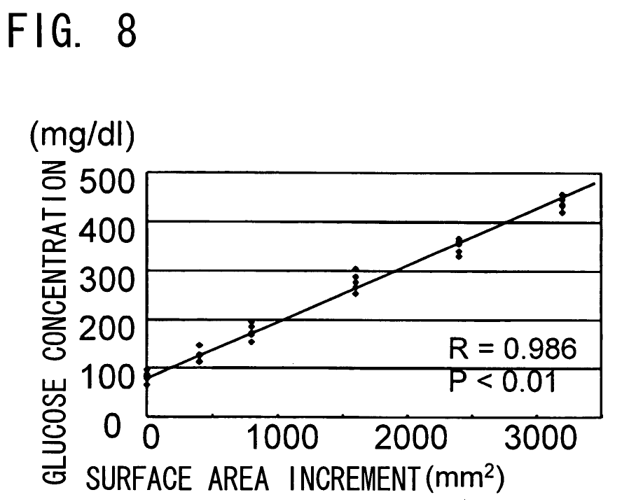

FIG. 8 shows the experimental result. As illustrated, it has been found that there is an extremely strong correlation between the surface area increment of the gummy jelly and the glucose concentration. A high value of 0.986 has been provided for the correlation coefficient r.

As a result of the simple linear regression analysis, proportionality has been established between the glucose concentration and the increment of surface area of the gummy jelly, and a regression equation shown in Formula 1 below has been provided where X (mg/dl) is the glucose concentration, and Y is the surface area increment (mm²) of the gummy jelly.

Y=8.8X−723.2 (Formula 1)

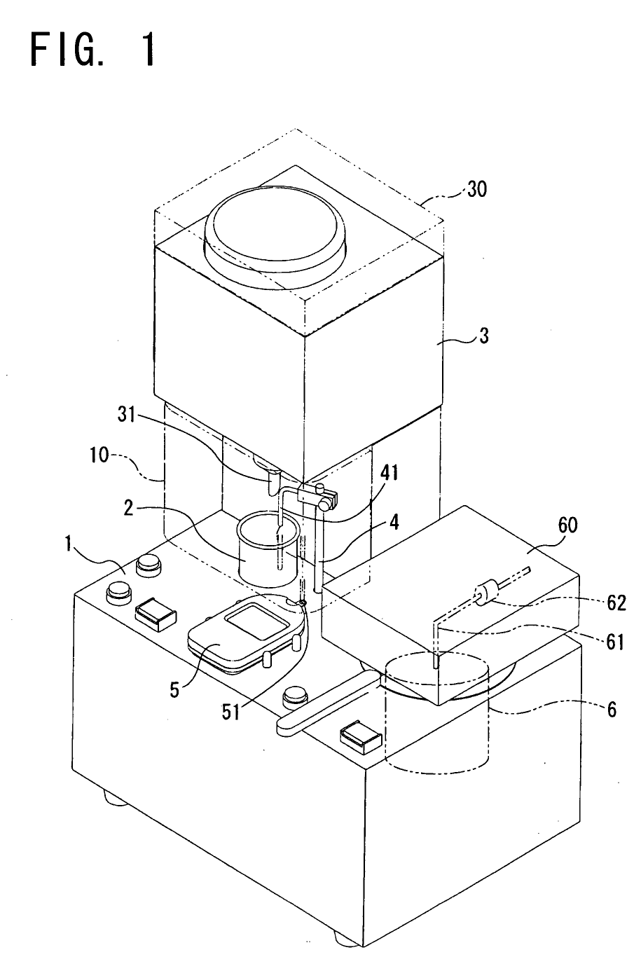

The present inventors have developed a masticatory efficiency measuring apparatus of the present invention shown in FIG. 1 based on the above experimental results.

As illustrated, a measuring beaker 2 having a volume of around 30 ml is placed on a measuring apparatus stand 1. Arranged above the measuring beaker 2 is a distilled water tank 3, which contains distilled water. A cover 30 is removably mounted on the distilled water tank 3. Attached inside the distilled water tank 3 are a heater (not shown) for heating the distilled water in the tank and a temperature sensor (not shown) for detecting the temperature of the distilled water in the tank. The distilled water in the tank is kept to 35° C. by the heater. Further, connected to the lower part of the distilled water tank 3 is a distilled water supply nozzle 31, which extends downward. A distilled water supply valve (not shown) intervenes on the nozzle 31. Opening the valve causes the distilled water in the distilled water tank 3 to pass through the distilled water supply nozzle 31 and pour into the measuring beaker 2.

Also placed on the measuring apparatus stand 1 are a supernatant liquid collector 4 for collecting the supernatant liquid in the measuring beaker 2, and a glucose meter 5 for measuring the concentration of glucose. The supernatant liquid collector 4 includes a supernatant liquid collecting glass rod 41, and a glass rod drive motor (not shown) for vertically and pivotally drive the glass rod 41. Drive of the motor causes the supernatant liquid collecting glass rod 41, as indicated by two-dot chain lines in the drawing, to move downward to dip into the supernatant liquid in the measuring beaker 2, and thereafter move upward, and further to pivot to a position above an electrode 51 of the glucose meter 5, and thereafter move downward. The supernatant liquid can thus be collected from the measuring beaker 2, and drop onto the electrode 51 of the glucose meter 5.

A stirring device (not shown) including a stirrer is arranged below the measuring beaker 2. Drive of the stirring device allows chewed gummy jelly pieces in the beaker 2 to be stirred in the distilled water.

A cover 10 covers the measuring beaker 2, distilled water supply nozzle 31, supernatant liquid collector 4, and the electrode 51 of the glucose meter 5. This can prevent contamination at the time of measurement of masticatory efficiency.

The measuring apparatus stand 1 contains a washing container 6 for the chewed gummy jelly pieces. Attached on the measuring apparatus stand 1 is a lid 60, which is opened and closed when the chewed gummy jelly pieces are put into the washing container 6. A tap water injection nozzle 61 is arranged above the washing container 6. A tap water supply valve 62 intervenes on the nozzle 61. Opening the valve 62 causes tap water to be supplied from the tap water injection nozzle 61 to the washing container 6, and wash the chewed gummy jelly pieces.

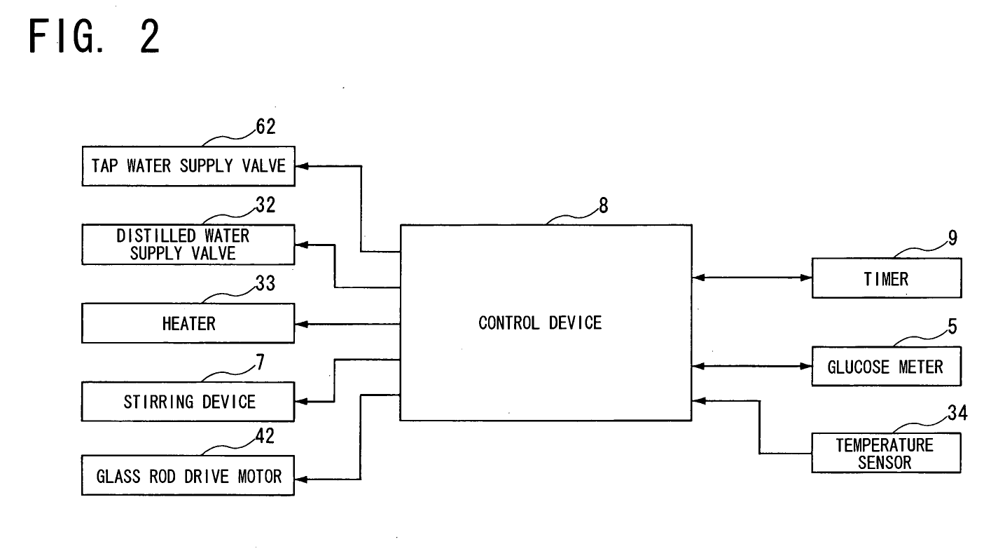

As shown in FIG. 2, a control device 8 is connected to the tap water supply valve 62, distilled water supply valve 32, heater 33, stirring device 7 and glass rod drive motor 42. The temperature sensor 34 is connected to the control device 8, so that the operation of the heater 33 is controlled based on the detection result of the temperature sensor 34. A timer 9 is also connected to the control device 8. Opening and closing of the tap water supply valve 62 and distilled water supply valve 32, and the operation of the stirring device 7, are controlled based on the timing result of the timer 9.

The glucose meter 5 is further connected to the control device 8. A built-in memory (not shown) of the control device 8 stores the regression equation shown in Formula 1 above. The surface area increment of the gummy jelly is calculated from the glucose concentration provided from the glucose meter 5, using the regression equation.

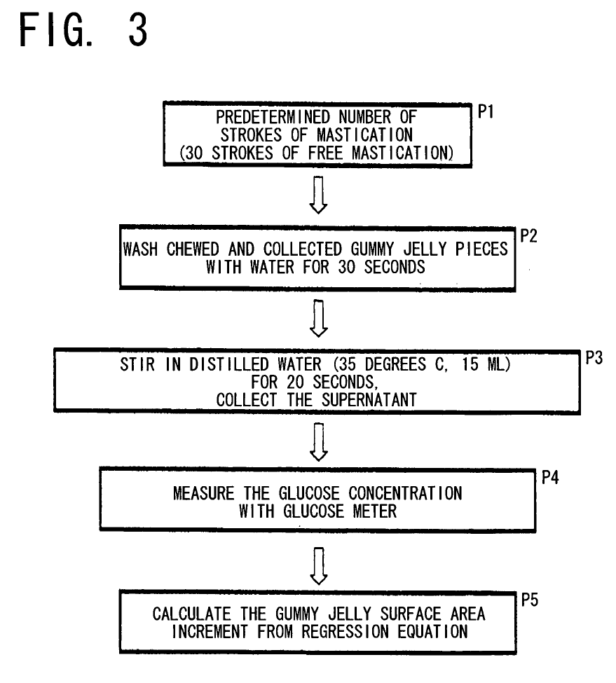

Next, a masticatory efficiency measuring method using the above masticatory efficiency measuring apparatus will be described with reference to FIG. 3. First in process P1, a subject freely masticates a gummy jelly by 30 strokes. Then all chewed pieces of the gummy jelly are collected. In process P2, the chewed and collected gummy jelly pieces are put into the washing container 6. Thereafter, a washing start operation is performed to open the tap water supply valve 62 and to cause the timer 9 to start a timing operation. Thereafter when 30 seconds elapse, the tap water supply valve 62 is closed. Tap water is thus supplied from the tap water injection nozzle 61 to the washing container 6 to wash the chewed gummy jelly pieces in the washing container 6 for 30 seconds. Next, the chewed gummy jelly pieces are taken out from the washing container 6, and put into the measuring beaker 2.

Subsequently in process P3, a measurement start operation is performed to open the distilled water supply valve 32 and to cause the timer 9 to start a timing operation. Thereafter when a predetermined time elapses, the distilled water supply valve 32 is closed. Further, the stirring device 7 starts its stirring operation, and the timer 9 also starts a timing operation. Thereafter when 20 seconds elapse, the stirring device 7 stops its stirring operation. Thus, 15 ml of distilled water pours from the distilled water supply tank 3 into the measuring beaker 2, and the chewed gummy jelly pieces in the beaker 2 are stirred in the distilled water for 20 seconds. Thereafter, the glass rod drive motor 42 of the supernatant liquid collector 4 is driven. The supernatant liquid is thereby collected from the measuring beaker 2, and drops on the electrode 51 of the glucose meter 5.

Next in process P4, the glucose meter 5 measures the concentration of glucose. Finally in process P5, the surface area increment of the gummy jelly is calculated from the measured glucose concentration, using the regression equation shown in Formula 1 above. The masticatory efficiency evaluating value is provided in this way.

The masticatory efficiency measuring apparatus of the present invention sets the washing time for chewed gummy jelly pieces to 30 seconds to thereby completely remove the saliva that has been attached to the chewed pieces while the gummy jelly has been masticated, and therefore, in the subsequent concentration measuring process, can accurately measure the concentration of only glucose eluted from the chewed gummy jelly pieces into the distilled water. In addition, the temperature of the distilled water to be supplied to the measuring beaker 2 can be accurately set to a predetermined temperature because the control device 8 controls the heater 33. Also, the chewed gummy jelly pieces can be stirred in the distilled water accurately for a predetermined time because the control device 8 controls the stirring device 7. This results in the ability to provide the measurement of high accuracy.

The present invention is not limited to the foregoing embodiment in construction but can be modified variously within the technical scope as set forth in the appended claims.

For example, the glucose concentration is measured with a glucose meter 5, but may be measured with other known methods.

Although distilled water is used as a stirring liquid, not only distilled water but also any liquid that does not influence the subsequent concentration measurement, such as pure water, may be used.

The surface area increment of the gummy jelly is calculated from the concentration of glucose, but may be calculated from the concentration of another component of the gummy jelly, such as gelatin.

The built-in memory of the control device 8 may store a plurality of regression equations that represent relationships between the glucose concentration and the surface area increment of the gummy jelly, such that a regression equation is selected from the plurality of regression equations according to the actual distilled water temperature detected by the temperature sensor 34 and the actual stirring time timed by the timer 9, and that the surface area increment of the gummy jelly may be calculated using the selected regression equation.

Further, the washing unit for the chewed gummy jelly pieces may be omitted.

Furthermore, the washing time for the chewed gummy jelly pieces and the temperature and stirring time for the distilled water are determined depending on the component of the gummy jelly and the quantity of the distilled water to be injected into the measuring beaker 2.

1. A masticatory efficiency measuring apparatus for measuring the masticatory efficiency using a food, the apparatus comprising a stirring liquid supply mechanism for supplying a stirring liquid to a measuring container; a heating mechanism for heating the stirring liquid; a stirring mechanism for stirring chewed pieces of a masticatory efficiency measuring food in the stirring liquid, with the measuring container containing the chewed pieces and the stirring liquid; a concentration measuring device for measuring the concentration of a component of the masticatory efficiency measuring food eluted into the stirring liquid from surfaces of the chewed pieces of the food; and a control device for controlling operations of the stirring liquid supply mechanism, heating mechanism, stirring mechanism and concentration measuring device, and for determining the masticatory efficiency evaluating value based on the measurement result of the concentration measuring device.

2. The masticatory efficiency measuring apparatus according to claim 1, wherein the control device is for causing the heating mechanism to heat the stirring liquid to a predetermined temperature, and the stirring mechanism to stir the chewed pieces for a predetermined time, and comprises:
relationship defining means that defines a relationship between the concentration of the component of the masticatory efficiency measuring food and the masticatory efficiency evaluating value, and in the case where the stirring liquid supplied from the stirring liquid supply mechanism to the measuring container has the predetermined temperature, and is stirred for the predetermined time; and
masticatory efficiency evaluating value determining means for determining the masticatory efficiency evaluating value from the measurement result of the concentration measuring device, in accordance with the relationship defined by the relationship defining means.

3. The masticatory efficiency measuring apparatus according to claim 1, further comprising thermometry means for measuring the temperature of the stirring liquid supplied from the stirring liquid supply mechanism to the measuring container; and timing means for measuring the time for which the chewed pieces of the masticatory efficiency measuring food are stirred in the stirring liquid, wherein the control device comprises:
relationship defining means that defines a plurality of relationships between the concentration of the component of the masticatory efficiency measuring food and the masticatory efficiency evaluating value; and
masticatory efficiency evaluating value determining means for selecting a relationship according to the measurement result of the thermometry means and the timing result of the timing means from the plurality of relationships defined by the relationship defining means, and for determining the masticatory efficiency evaluating value from the measurement result of the concentration measuring device, in accordance with the selected relationship.

4. The masticatory efficiency measuring apparatus according to any one of claims 1 to 3, further comprising a supernatant liquid collecting/supply mechanism for collecting the supernatant liquid in the measuring container for supply to the concentration measuring device, the supernatant liquid collecting/supply mechanism being operation-controlled by the control device.

5. The masticatory efficiency measuring apparatus according to any one of claims 1 to 3, further comprising a washing mechanism for washing the chewed pieces of the masticatory efficiency measuring food with washing water, the washing mechanism being operation-controlled by the control device.

6. The masticatory efficiency measuring apparatus according to claim 5, wherein the control device causes the washing mechanism to wash the chewed pieces of the masticatory efficiency measuring food for a predetermined time.

7. The masticatory efficiency measuring apparatus according to any one of claims 1 to 3, wherein the masticatory efficiency measuring food is gummy jelly, and the concentration measuring device measures the concentration of glucose, which is a component of the gummy jelly.

8. A masticatory efficiency measuring method for measuring the masticatory efficiency using a food, the method comprising the steps of:
supplying a stirring liquid of a predetermined temperature to a measuring container, with the measuring container containing chewed pieces of a masticatory efficiency measuring food;
stirring the chewed pieces in the stirring liquid for a predetermined time;
measuring the concentration of a component of the masticatory efficiency measuring food eluted into the stirring liquid from surfaces of the chewed pieces; and
determining the masticatory efficiency evaluating value from the measured concentration, in accordance with a relationship between the concentration of the component of the masticatory efficiency measuring food and the masticatory efficiency evaluating value, and in the case where the stirring liquid supplied to the measuring container has the predetermined temperature, and is stirred for the predetermined time.

9. The masticatory efficiency measuring method according to claim 8, wherein the masticatory efficiency measuring food is gummy jelly, and the concentration measuring step comprises measuring the concentration of glucose, which is a component of the gummy jelly.

10. A masticatory efficiency measuring method using a masticatory efficiency measuring apparatus comprising a stirring liquid supply mechanism for supplying a stirring liquid to a measuring container; a heating mechanism for heating the stirring liquid; a stirring mechanism for stirring chewed pieces of a masticatory efficiency measuring food in the stirring liquid, with the measuring container containing the chewed pieces and the stirring liquid; a concentration measuring device for measuring the concentration of a component of the masticatory efficiency measuring food eluted into the stirring liquid from surfaces of the chewed pieces of the food; and a control device for controlling operations of the stirring liquid supply mechanism, heating mechanism, stirring mechanism and concentration measuring device, and for determining the masticatory efficiency evaluating value based on the measurement result of the concentration measuring device, the masticatory efficiency measuring method comprising the steps of:
supplying the stirring liquid to the measuring container with the stirring liquid supply mechanism, with the measuring container containing the chewed pieces of the masticatory efficiency measuring food;
stirring the chewed pieces in the stirring liquid with the stirring mechanism;
measuring the concentration of the component of the masticatory efficiency measuring food eluted into the stirring liquid from surfaces of the chewed pieces with the concentration measuring device; and
determining the masticatory efficiency evaluating value with the control device based on the measurement result of the concentration measuring device.

11. The masticatory efficiency measuring method according to claim 10, wherein the control device is for causing the heating mechanism to heat the stirring liquid to a predetermined temperature, and comprises relationship defining means that defines a relationship between the concentration of the component of the masticatory efficiency measuring food and the masticatory efficiency evaluating value, and in the case where the stirring liquid supplied from the stirring liquid supply mechanism to the measuring container has the predetermined temperature, and is stirred for a predetermined time, wherein the stirring step comprises stirring the chewed pieces of the masticatory efficiency measuring food in the stirring liquid for the predetermined time, and the masticatory efficiency evaluating value determining step comprises determining the masticatory efficiency evaluating value from the measurement result of the concentration measuring device, in accordance with the relationship defined by the relationship defining means.

12. The masticatory efficiency measuring method according to claim 10, wherein the masticatory efficiency measuring apparatus further comprises thermometry means for measuring the temperature of the stirring liquid supplied from the stirring liquid supply mechanism to the measuring container; and timing means for measuring the time for which the chewed pieces of the masticatory efficiency measuring food are stirred in the stirring liquid, wherein the control device comprises relationship defining means that defines a plurality of relationships between the concentration of the component of the masticatory efficiency measuring food and the masticatory efficiency evaluating value, wherein the masticatory efficiency evaluating value determining step comprises selecting a relationship according to the measurement result of the thermometry means and the timing result of the timing means from the plurality of relationships defined by the relationship defining means, and determining the masticatory efficiency evaluating value from the measurement result of the concentration measuring device, in accordance with the selected relationship.

13. The masticatory efficiency measuring method according to any one of claims 10 to 12, wherein the masticatory efficiency measuring apparatus further comprises a supernatant liquid collecting/supply mechanism for collecting the supernatant liquid in the measuring container for supply to the concentration measuring device, wherein the step of stirring the chewed pieces of the masticatory efficiency measuring food in the stirring liquid is followed by the step of collecting the supernatant liquid in the measuring container for supply to the concentration measuring device with the supernatant liquid collecting/supply mechanism.

14. The masticatory efficiency measuring method according to any one of claims 10 to 12, wherein the masticatory efficiency measuring apparatus further comprises a washing mechanism for washing the chewed pieces of the masticatory efficiency measuring food with washing water, wherein the method comprises the step of washing the chewed pieces of the masticatory efficiency measuring food with washing water with the washing mechanism.

15. The masticatory efficiency measuring method according to claim 14, wherein the washing step comprises washing the chewed pieces of the masticatory efficiency measuring food for a predetermined time.

16. The masticatory efficiency measuring method according to any one of claims 10 to 12, wherein the masticatory efficiency measuring food is gummy jelly, and the concentration measuring step comprises measuring the concentration of glucose, which is a component of the gummy jelly.
